(19) United States
(12) Patent Application Publication
(10) Pub. No.: US 2018/0061300 A1
(43) Pub. Date: Mar. 1, 2018

(54) OLED-PWM DRIVING METHOD

(71) Applicant: Shenzhen China Star Optoelectronics Technology Co., Ltd., Shenzhen (CN)

(72) Inventors: Xiaolong Chen, Shenzhen (CN); Ming Jong Jou, Shenzhen (CN); Chih Hao Wu, Shenzhen (CN)

(21) Appl. No.: 15/328,511

(22) PCT Filed: Jan. 9, 2017
(86) PCT No.: PCT/CN2017/070644

§ 371 Date: Jun. 7, 2017

(30) Foreign Application Priority Data
Aug. 31, 2016 (CN) 201610794331.6

(51) Int. Cl. G09G 3/20; G09G 3/3208

(52) U.S. Cl. CPC G09G 3/2022; G09G 3/3208; G09G 5/06; G09G 2320/0247; G09G 2320/0233; G09G 3/2003

(57) ABSTRACT

Disclosed is an OLED-PWM driving method, which includes looking up, based on a look-up table, assignment of bright subframes and non-bright subframes of each gray scale value in a whole frame, and scattering, based on the assignment of bright subframes and non-bright subframes of each gray scale value in the whole frame, corresponding gray scale energy according to a predetermined rule, so that the gray scale energy is uniformly distributed in the whole frame.

### CROSS-REFERENCE TO RELATED APPLICATIONS

The present application claims the priority of Chinese patent application CN 201610794331.6, entitled “OLED-PWM driving method” and filed on Aug. 31, 2016, the entirety of which is incorporated herein by reference.

### FIELD OF THE INVENTION

The present disclosure relates to the technical field of organic display control, and in particular, to an OLED-PWM driving method.

### BACKGROUND OF THE INVENTION

As shown in FIG. 1, a 3T1C (3 transistors, T1, T2 and T3, and 1 capacitor Cst) pixel driving circuit of an OLED (Organic Light Emitting Diode) is provided, wherein, D is a data driving signal, G is a charge scanning signal, DG is a discharge scanning signal, Ovdd is a constant current driving signal, and Ovss is an output voltage of an active light-emitting diode. When the circuit is digitally driven, only two Gamma voltage levels, i.e., Gamma_a (brightest) and Gamma_b (darkest), are outputted at V_{A}. In accordance with the transistor current-voltage I-V Equation:

I_{ds,sat}=k·(V_{GS}−V_{th,T2})²=k·(V_{A}−V_{S}−V_{th,T2})²,

wherein, I_{ds,sat} is a transistor conduction current, k is an intrinsic conductivity factor, V_{GS} is a transistor gate-source voltage, V_{th,T2} is a threshold voltage of the transistor T2, V_{A} represents V_{A} point voltage, and V_{S} represents V_{S} point voltage. The variation ΔVth of transistor threshold voltage Vth caused by device degradation or inconsistency is small relative to the variation (VA-VS). Therefore, as compared to an analog driving mode, a digital driving mode can suppress brightness non-uniformity of OLED.

When the pixel driving circuit of FIG. 1 operates, the transistor T1 charges the VA point voltage, and the transistor T3 discharges the VA point voltage. Finally, the VA is controlled to output only two Gamma voltage levels and a gray scale is cutout by in a PWM (Pulse-Width Modulation) mode.

Meanwhile, the PWM driving mode operates to control subframe charging time based on activation time of the transistors T1 and T3, and display an image based on the principle that the perception of brightness to human eyes is the integration with respect to time. However, there is a deviation of integration of brightness to human eyes, leading to an inconsistency between a gray scale detected by human eyes and an actual gray scale, which may cause the problem of dynamic false contours and flickers.

Further, as compared to LCD display, OLED has the advantages such as high contrast, wide color range, broad viewing angle, and free of backlight, but it has a short service life.

### SUMMARY OF THE INVENTION

In order to overcome the above problems, the present disclosure provides an OLED PWM driving method, which reduces the problems of dynamic false contours and flickers, increases image contrast and improves display quality.

According to one embodiment of the present disclosure, an OLED-PWM driving method is provided, comprising:

looking up, based on a look-up table, assignment of bright subframes and non-bright subframes of each gray scale value in a whole frame; and

scattering, based on the assignment of bright subframes and non-bright subframes of each gray scale value in the whole frame, corresponding gray scale energy according to a predetermined rule, so that the gray scale energy is uniformly distributed in the whole frame.

According to one embodiment of the present disclosure, prior to looking up the assignment of bright subframes and non-bright subframes of each gray scale value in the whole frame based on the look-up table, the method also comprises pretreating an input image to reduce or increase its average pixel value, so that the average pixel value is within a predetermined range.

According to one embodiment of the present disclosure, scattering the corresponding gray scale energy according to the predetermined rule further comprises:

equally dividing, based on gray scale number, driving signal width of each gray scale value into a predetermined number of new subframes;

determining, based on the assignment of bright subframes and non-bright subframes of each gray scale value in the whole frame, new subframes corresponding to bright subframe driving signal width of each gray scale value and new subframes corresponding to non-bright subframe driving signal width of each gray scale value; and

evenly inserting new bright subframes corresponding to the bright subframe driving signal width of each gray scale value into new non-bright subframes corresponding to the non-bright subframe driving signal width of each gray scale value, so as to scatter the gray scale energy.

According to one embodiment of the present disclosure, 1 is subtracted from the gray scale number to obtain the predetermined number.

According to one embodiment of the present disclosure, evenly inserting new bright subframes corresponding to the bright subframe driving signal width of each gray scale value into new non-bright subframes corresponding to the non-bright subframe driving signal width of each gray scale value further comprises:

dividing the predetermined number of new subframes equally divided from the whole frame into a plurality of predetermined groups in an equal-weight manner; and

assigning the new bright subframes and new non-bright subframes into the groups in an equal-weight manner.

According to one embodiment of the present disclosure, in case the number of new subframes, the number of new bright subframes and the number of new non-bright subframes cannot be divided in an equal-weight manner, their corresponding remainder subframes are assigned into corresponding number of groups, so that the weights of new subframes, new bright subframes and new non-bright subframes of each group are close.

According to one embodiment of the present disclosure, among different groups, the weights of new bright subframes are interchangeable, and the weights of new non-bright subframes are interchangeable.

According to one embodiment of the present disclosure, in each group, the new bright subframes are continuously arranged, and the new non-bright subframes are continuously arranged.

According to one embodiment of the present disclosure, the method further comprises:

equally dividing, based on the gray scale number, blank time between the driving time of bright subframes and non-bright subframes of each gray scale value in the whole frame into a predetermined number of blank subframes, which are divided into a plurality of predetermined groups in an equal-weight manner, and inserted between new subframe groups.

According to one embodiment of the present disclosure, the blank subframes of the predetermined groups are inserted prior to or posterior to the new subframe groups.

The present disclosure has the following advantages:

by scattering the energy of each gray scale, the gray scale energy is uniformly distributed in the whole frame, so as to alleviate the problems of dynamic false contours and flickers, increase image contrast and improve display quality.

Other advantages, objectives and features of the present disclosure will be further explained in the following description, and partly based on the understanding and study of the following, it will be apparent for those skilled in the art or can be taught through implementation of the present disclosure. The objectives and other advantages of the present disclosure will be achieved and obtained through the structure specifically pointed out in the description, claims, and the accompanying drawings.

### BRIEF DESCRIPTION OF THE DRAWINGS

The drawings are provided for further understanding of the technical solution of the present application or the prior art, and constitute one part of the description, wherein, the drawings explaining the embodiments of the present application serve to explain the technical solution of the present application in conjunction with the embodiments of the present application, rather than to limit the technical solution of the present application. In the drawings:

FIG. 1 schematically shows an OLED 3TIC pixel driving circuit in the prior art;

FIG. 2a schematically shows a 8-bit 8-subframe driving signal width in the prior art;

FIG. 2b schematically shows OLED-PWM gray scale 72 and gray scale 63 in the prior art;

FIG. 2c schematically shows gray scale 72 and gray scale 63 according to one embodiment of the present disclosure;

FIG. 3 schematically shows a flow chart of a method according to one embodiment of the present disclosure; and

FIG. 4 schematically shows a gray histogram of a pixel APL before and after adjustment according to one embodiment of the present disclosure.

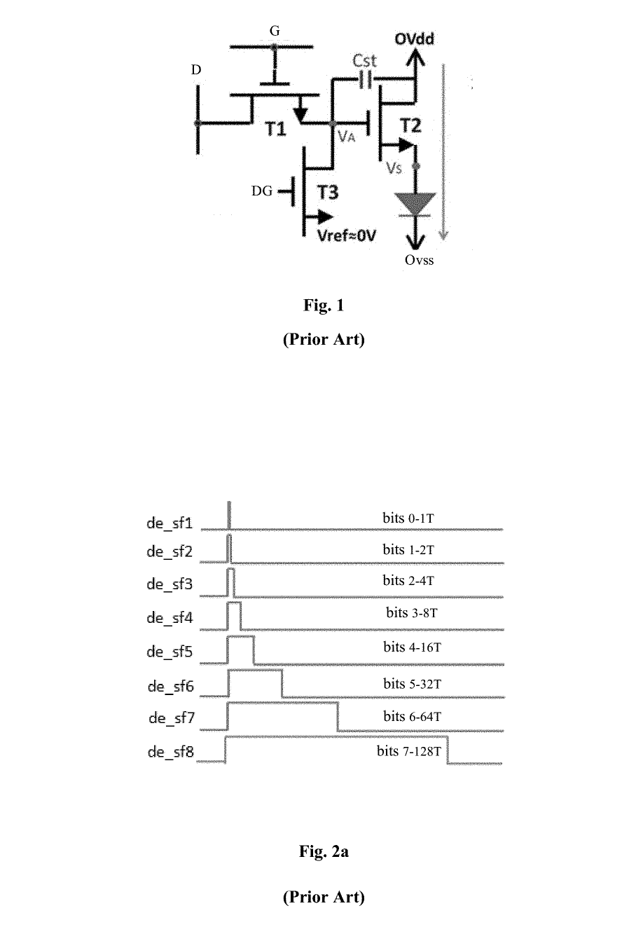

### DETAILED DESCRIPTION OF THE EMBODIMENTS

In order to fully understand how the technical solutions of the present disclosure can be applied to solve the technical problems and achieve the corresponding technical effects and to implement thereby, the embodiments of the present disclosure will be further explained in detail in connection with the accompanying drawings and examples. The examples of the present application and various features of the examples, without conflicts, can be combined with one another, and all resulting technical solutions fall within the scope of the present disclosure.

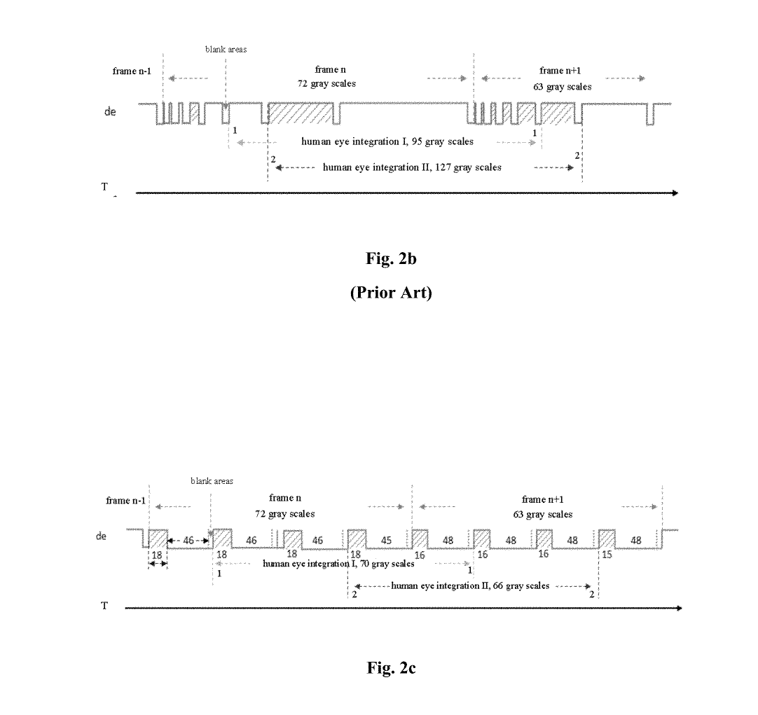

A conventional OLED-PWM driving system provides a plurality of gray scales based on the difference in display time of subframes. With 8-bit, 8-subframe and output gray scale 0-255 as an example, a weight ratio of display time of 8 subframes is 1:2:4:8:16:32:64:128, corresponding to bit 0, bit 1, bit 2, bit 3, bit 4, bit 5, bit 6 and bit 7, respectively. As shown in FIG. 2a, de_sfn schematically shows width of a driving signal de of an n^{th} subframe.

When a pixel shows gray scale 72 (01001000B), a 3^{rd} bit and a 6^{th} bit of its driving signal are 1. Thus, a 4^{th} subframe and a 7^{th} subframe corresponding to these two bits are bright, corresponding to a shade part in frame n in FIG. 2b. The other subframes of the pixel are not bright, at which time, the integration of human eyes to a current frame brightness of the pixel is 72 gray scales. When the pixel shows gray scale 63 (00111111B) in a next frame n+1, a 0^{th} bit to a 5^{th} bit of its driving signal are 1. Thus, a 1^{st} to a 6^{th} subframes corresponding to these six bits are bright, and the other subframes are not bright. The 1^{st} to 6^{th} subframes correspond to a shade part in the frame n+1 in FIG. 2b, at which time, the integration of human eyes to a current frame brightness of the pixel is 63 gray scales.

However, the integration of human eyes to brightness is not always ideal. In the case of integration of human eyes to part 1-1 shown in FIG. 2b, the integration of pixel brightness of a current frame is 95 gray scales. In the case of integration of human eyes to part 2-1, the integration of pixel brightness of a current frame is 127 gray scales. Therefore, the visual effect of human eyes is quite different from an original gray scale of an image. On the other hand, as an 8^{th} subframe of gray scale 72 is not bright, at least one subframe of weight 128 is not bright from a 7^{th} bright subframe of gray scale 72 to the first bright subframe of a next frame, which usually causes the problem of dynamic false contours and flickers.

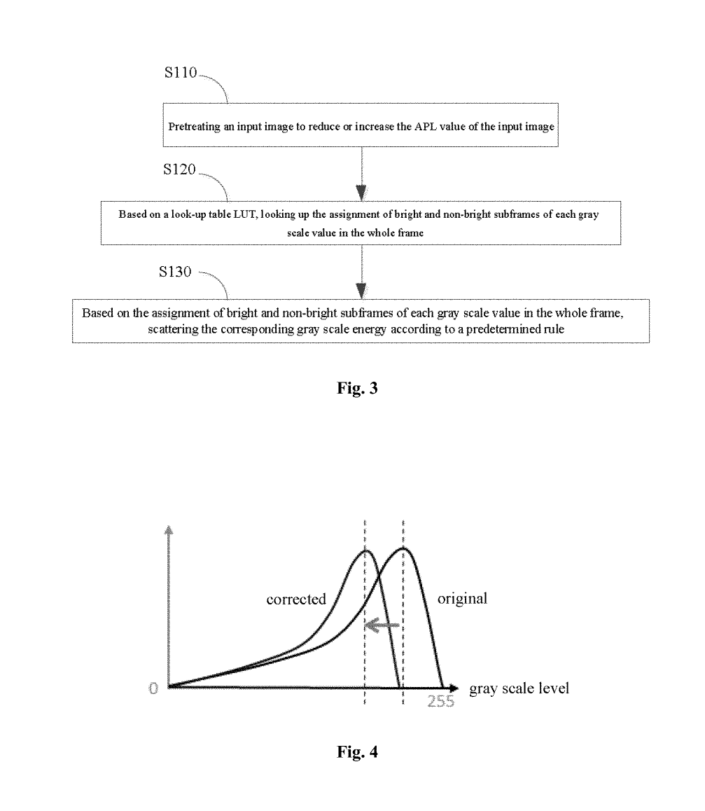

In order to solve the above problem, the present disclosure provides an OLED-PWM driving method, and FIG. 3 shows a flow chart of a method according to an example of the present disclosure. Now with reference to FIG. 3, the present disclosure will be explained in detail.

In order to save power consumption and increase OLED display life, in step S110, an input image is pretreated to reduce or increase an APL value of the input image, so that an average pixel value is within a predetermined range.

Specifically, the APL value represents the average pixel value, which is an average value calculated from three subpixels RGB in one pixel. The larger the APL value is, the brighter the overall image is, otherwise the darker. If a displayed image is too bright, the power consumption required for the OLED driving system is increased, and the display life of the OLED is also affected. If the APL value calculated according to the RGB values of the input image exceeds a preset threshold (for example, 192), new R′G′B′ values can be calculated according to gray histogram of the image by using existing algorithm, to properly reduce the APL value. The reduction is based on the principle of maintaining original quality of the image to gain a better effect (for example, by percentage) between APL and gray histogram of the new image displayed, so as to achieve the purpose of reducing the power consumption and increasing the OLED life. FIG. 4 schematically shows a gray histogram before and after the adjustment of APL.

In order to improve image contrast, sometimes the input image is pretreated to increase the APL value of the input image. If the APL value of the input image is below a preset threshold (for example, 64), indicating that the overall image is dark, the APL value of the image is properly increased to improve the image contrast, and the increase is based on the principle of gaining a better effect between APL and gray histogram of the new image displayed (for example, by percentage) to achieve the purpose of improving the image contrast.

Next, in step S120, an assignment of bright subframes and non-bright subframes of each gray scale value in a whole frame image is looked up based on an LUT (Look-Up-Table). Specifically, with respect to an input gray scale value of each pixel of the input image, display assignment of bright subframes and non-bright subframes corresponding to the input gray scale value can be found through the LUT. For example, in a conventional OLED-PWM driving system shown in FIG. 2b, for the 8-bit 8-subframe and output gray scale 0-255, the weight ratio of display time of 8 subframes is 1:2:4:8:16:32:64:128. When gray scale 72 is displayed, it can be found by the LUT that corresponding 3^{rd} and 6^{th} bits are 1. The subframes corresponding to these two bits are bright, and other subframes are not bright. Also, based on the assignment of bright subframes and non-bright subframes of each gray scale value in the whole frame, together with the weights of display time of 8 subframes, driving signal widths of bright subframes and non-bright subframes can be calculated. Alternatively, when other PWM driving modes can be used, the driving signal widths of bright subframes and non-bright subframes can be calculated by other methods, to obtain the assignment of bright subframes and non-bright subframes of each gray scale value in the whole frame.

Finally, in step S130, based on the assignment of bright subframes and non-bright subframes of each gray scale value in the whole frame, corresponding gray scale energy is scattered according to a predetermined rule, so that the gray scale energy is uniformly distributed in the whole frame. Scattering the corresponding gray scale energy according to the predetermined rule further comprises the following steps.

Firstly, based on the gray scale number, the driving signal width of each gray scale value is equally divided into a predetermined number of new subframes. Herein, the gray scale number refers to the number of overall display gray scales of a display device. For example, for 8-bit display, totally 256 (0-255) gray scales can be outputted, and the gray scale number is 256. As OLED-PWM provides gray scale based on a duration of subframe opening time in combination with a principal that brightness perception of human eyes is integration with respect to time. Time integration is not required for gray scale 0, and thus, in the case that the gray scale number is 256, the driving signal width of each gray scale value is equally divided into 255 new subframes. Therefore, the ratio of driving signal width of each new subframe to whole frame driving signal width is equal to 1 divided by the predetermined number, and the new subframes each have the same weight. In other words, a difference between the grey scale number and the predetermined number of new subframes is equal to 1.

Also, the driving signal width herein comprises the driving signal widths of bright subframes of each gray scale value and the driving signal widths of non-bright subframes of each gray scale value. For example, in the conventional OLED-PWM driving system shown in FIG. 2b, the driving signal width of gray scale 72 comprises the subframe driving signal widths corresponding to bright subframe bit 3 and bit 6, and also comprises the subframe driving signal widths corresponding to other non-bright six bits. It should be noted that, in order to distinguish the subframes before and after scattering the gray scale energy according to the predetermined rule, the subframes posterior to equal division of the driving signal width of each gray scale are described as new subframes, new bright subframes and new non-bright subframes, and the subframes prior to equal division of the driving signal width of each gray scale are described as subframes, bright subframes and non-bright subframes.

Then, based on the assignment of bright subframes and non-bright subframes of each gray scale value in the whole frame, new subframes corresponding to the bright subframe driving signal width of each gray scale value and new subframes corresponding to the non-bright subframe driving signal width of each gray scale value are determined. Specifically, the driving signal widths of bright subframes and non-bright subframes can be seen from the assignment of bright subframes and non-bright subframes of each gray scale value in the whole frame. In combination of the rule of dividing each new subframe, it can be seen that the ratio of driving signal width of each new bright subframe and non-bright subframe to whole frame driving signal width is equal to 1 divided by the predetermined number. Thus, the numbers of both new bright subframes and new non-bright subframes are increased, so that, the gray scale energy of the original bright subframes can be scattered to a plurality of new bright subframes.

Finally, the new subframes corresponding to the bright subframe driving signal width of each gray scale value are evenly inserted into the new subframes corresponding to the non-bright subframe driving signal width of each gray scale value, so as to scatter the gray scale energy. Thus, the gray scale energy can be uniformly distributed in the whole frame, so as to reduce the problem of dynamic false contours and flickers of OLED.

Specifically, for evenly inserting the new subframes corresponding to the bright subframe driving signal width of each gray scale value into the new subframes corresponding to the non-bright subframe driving signal width of each gray scale value, different methods can be used. In one embodiment of the present disclosure, firstly a predetermined number of new subframes equally divided from the whole frame are divided into a plurality of groups in an equal-weight manner. That is, the groups each have the same number of new subframes. Then, the new subframes corresponding to the bright subframe driving signal width of each gray scale value and the new subframes corresponding to the non-bright subframe driving signal width of each gray scale value are assigned to the groups in an equal-weight manner. In other words, the groups each have the same number of new bright subframes, and the same number of new non-bright subframes. The new bright subframes and new non-bright subframes are evenly assigned to the groups. The new bright subframes in the groups have the same weight, and the new non-bright subframes also have the same weight in the groups.

However, sometimes the gray scale energy cannot be evenly assigned to the plurality of predetermined groups. As stated above, one whole frame is divided into 255 subframes. Provided that the 255 subframes are divided to 4 groups, 255 cannot be exactly divided by 4. At this time, the new subframes, based on the remainder of exact division, are inserted into the groups. The groups to which the remainder is not enough to insert are eliminated, and the remainder new subframes are evenly inserted into the remaining groups, with one subframe being inserted into one group. For example, the 255 subframes are divided into 4 groups, each having 63 subframes, with 3 subframes left. These 3 subframes cannot be inserted into 4 groups. Thus one group is eliminated, with 3 groups left, and the remainder 3 subframes are inserted into the left 3 groups in any order. Thus, the group weights of the whole frame are 64:64:64:63, in which the group having the weight of 63 can be placed in any position among the groups.

Sometimes the number of new bright subframes or new non-bright subframes can be exactly divided by the number of groups. For example, in the case 72 gray scales are displayed, as 72/4=18, the weight of the new bright subframes in each group is 18, and the weight of the new non-bright subframes in each group is 46 (64−18=46) or 45 (63−18=45). That is, the weights of new bright subframes/new non-bright subframes in the four groups are 18/46:18/46:18/46:18/45, as shown in FIG. 2c. Therein, the position of weight 45 of new non-bright subframes in the 4^{th} subgroup is not limited thereto. It can be determined depending on particular image conditions. The position can just be interchanged with the new non-bright subframes located in the non-bright part, for example, 18/46:18/45:8/46:18/46.

Sometimes the number of new bright subframes or new non-bright subframes cannot be exactly divided by the number of groups. For example, in the case 63 gray scales are displayed, as 63 cannot be exactly divided by 4, with a quotient being 15 and a remainder being 3, the weights of new bright subframes are assigned as 16:16:16:15. That is, the weights of new bright subframes/new non-bright subframes are 16/48:16/48:16/48:15/48, as shown in FIG. 2c.

Of course, the number of groups of new bright subframes/new non-bright subframes can be set randomly. For example, 63 gray scales can be divided into 8 groups. The weights of the whole frame are divided to eight groups: 32, 32, 32, 32, 32, 32, 32 and 31, totally 255. 63 is divided by 8, to produce a quotient of 7 and a remainder of 7. The remainder 7 is added to first 7 groups in 8 new subframes. As a result, the weights of bright subframes in the groups are 8, 8, 8, 8, 8, 8, 8 and 7. The weights of non-bright subframes are 24 (32−8=24 or 31−7=24). That is, the weights of bright/non-bright subframes of eight groups are 8/24, 8/24, 8/24, 8/24, 8/24, 8/24, 8/24 and 7/24, respectively. Therein, the position of weight 7 of bright subframes in the 8^{th} group is not limited thereto. It can be determined depending on particular conditions of image, but just interchanged with the position of bright subframes.

In one embodiment of the present disclosure, in order to facilitate brightness display, the new bright subframes in each group are continuously arranged, and the new non-bright subframes in each group are continuously arranged, as shown in FIG. 2c.

As shown in FIG. 2b, a blank area is arranged between driving signal widths to distinguish each driving signal width. Corresponding to the blank area, in one embodiment of the present disclosure, based on the gray scale number, the blank area between driving signal widths of bright subframes and non-bright subframes of each gray scale value in the whole frame is equally divided into a predetermined number of blank subframes, which are divided into a plurality of predetermined groups in an equal-weight manner, and inserted between the new subframe groups. Thus, each group can be distinguished. In one embodiment of the present disclosure, the blank subframes of the predetermined groups are inserted prior to or posterior to the new subframes groups, as shown in FIG. 2c.

Under the driving structure of the present disclosure, in the case of integration of human eyes to part 1-1 shown in FIG. 2b, the integration of pixel brightness of the current frame is 70 gray scales. In the case of integration of human eyes to part 2-2, the integration of pixel brightness of the current frame is 66 gray scales. As compared to the 95 gray scales and 127 gray scales in the conventional driving structure, the difference between the integration of brightness and the original gray scales of the image is small, thereby improving the pixel display quality.

On the other hand, as the energy is scattered and relatively evenly distributed in the whole frame, the problems of dynamic false contours and flickers are reduced. In the present disclosure, the weight of a largest non-bright subframe between two bright subframes of the frames n and n+1 is 48, which is obvious improvement as compared to 128 gray scales in FIG. 2b. The subframes of the other gray scales are assigned in a similar way.

The above description of the embodiments disclosed by the present disclosure should not be construed as limitations of the present disclosure, but merely as exemplifications of preferred embodiments thereof. Any variations or replacements that can be readily envisioned by those skilled in the art are intended to be within the scope of the present disclosure. Hence, the scope of the present disclosure should be subject to the scope defined in the claims.

1. An OLED-PWM driving method, comprising:
looking up, based on a look-up table, assignment of bright subframes and non-bright subframes of each gray scale value in a whole frame; and
scattering, based on the assignment of bright subframes and non-bright subframes of each gray scale value in the whole frame, corresponding gray scale energy according to a predetermined rule, so that the gray scale energy is uniformly distributed in the whole frame.

2. The method according to claim 1, wherein, prior to looking up the assignment of bright subframes and non-bright subframes of each gray scale value in the whole frame based on the look-up table, the method also comprises pretreating an input image to reduce or increase its average pixel value, so that the average pixel value is within a predetermined range.

3. The method according to claim 1, wherein scattering corresponding gray scale energy according to the predetermined rule further comprises:
equally dividing, based on a gray scale number, driving signal width of each gray scale value into a predetermined number of new subframes;
determining, based on the assignment of bright subframes and non-bright subframes of each gray scale value in the whole frame, new subframes corresponding to bright subframe driving signal width of each gray scale value and new subframes corresponding to non-bright subframe driving signal width of each gray scale value; and
evenly inserting new bright subframes corresponding to the bright subframe driving signal width of each gray scale value into new non-bright subframes corresponding to the non-bright subframe driving signal width of each gray scale value, so as to scatter the gray scale energy.

4. The method according to claim 2, wherein scattering the corresponding gray scale energy according to the predetermined rule further comprises:
equally dividing, based on a gray scale number, driving signal width of each gray scale value into a predetermined number of new subframes;
determining, based on the assignment of bright subframes and non-bright subframes of each gray scale value in the whole frame, new subframes corresponding to bright subframe driving signal width of each gray scale value and new subframes corresponding to non-bright subframe driving signal width of each gray scale value; and
evenly inserting new bright subframes corresponding to the bright subframe driving signal width of each gray scale value into new non-bright subframes corresponding to the non-bright subframe driving signal width of each gray scale value, so as to scatter the gray scale energy.

5. The method according to claim 4, comprising subtracting 1 from the gray scale number to obtain the predetermined number.

6. The method according to claim 3, wherein evenly inserting new bright subframes corresponding to bright subframe driving time of each gray scale value into new non-bright subframes corresponding to non-bright subframe driving time of each gray scale value further comprises:
dividing the predetermined number of new subframes equally divided from the whole frame into a plurality of predetermined groups in an equal-weight manner; and
assigning the new bright subframes and new non-bright subframes into the groups in an equal-weight manner.

7. The method according to claim 4, wherein evenly inserting new bright subframes corresponding to the bright subframe driving time of each gray scale value into new non-bright subframes corresponding to the non-bright subframe driving time of each gray scale value further comprises:
dividing the predetermined number of new subframes equally divided from the whole frame into a plurality of predetermined groups in an equal-weight manner; and
assigning the new bright subframes and new non-bright subframes into the groups in an equal-weight manner.

8. The method according to claim 5, wherein evenly inserting new bright subframes corresponding to the bright subframe driving time of each gray scale value into new non-bright subframes corresponding to the non-bright subframe driving time of each gray scale value further comprises:
dividing the predetermined number of new subframes equally divided from the whole frame into a plurality of predetermined groups in an equal-weight manner; and
assigning the new bright subframes and new non-bright subframes into the groups in an equal-weight manner.

9. The method according to claim 6, wherein, in case the number of new subframes, the number of new bright subframes, and the number of new non-bright subframes cannot be divided in an equal-weight manner, their corresponding remainder subframes are assigned into corresponding number of groups, so that weights of new subframes, new bright subframes, and new non-bright subframes of each group are close.

10. The method according to claim 7, wherein, in case the number of new subframes, the number of new bright subframes, and the number of new non-bright subframes cannot be divided in an equal-weight manner, their corresponding remainder subframes are assigned into corresponding number of groups, so that weights of new subframes, new bright subframes, and new non-bright subframes of each group are close.

11. The method according to claim 8, wherein, in case the number of new subframes, the number of new bright subframes, and the number of new non-bright subframes cannot be divided in an equal-weight manner, their corresponding remainder subframes are assigned into corresponding number of groups, so that weights of new subframes, new bright subframes and new non-bright subframes of each group are close.

12. The method according to claim 9, wherein among different groups, the weights of the new bright subframes are interchangeable, and the weights of the new non-bright subframes are interchangeable.

13. The method according to claim 10, wherein among different groups, the weights of the new bright subframes are interchangeable, and the weights of the new non-bright subframes are interchangeable.

14. The method according to claim 11, wherein among different groups, the weights of the new bright subframes are interchangeable, and the weights of the new non-bright subframes are interchangeable.

15. The method according to claim 3, wherein in each group, the new bright subframes are continuously arranged, and the new non-bright subframes are continuously arranged.

16. The method according to claim 4, wherein in each group, the new bright subframes are continuously arranged, and the new non-bright subframes are continuously arranged.

17. The method according to claim 3, wherein the method also comprises:
equally dividing, based on the gray scale number, blank time between the driving time of bright subframes and non-bright subframes of each gray scale value in the whole frame into a predetermined number of blank subframes, which are divided into a plurality of predetermined groups in an equal-weight manner, and inserted between new subframe groups.

18. The method according to claim 4, wherein the method also comprises:
equally dividing, based on the gray scale number, blank time between the driving time of bright subframes and non-bright subframes of each gray scale value in the whole frame into a predetermined number of blank subframes, which are divided into a plurality of predetermined groups in an equal-weight manner, and inserted between new subframe groups.

19. The method according to claim 17, wherein the blank subframes of the predetermined groups are inserted prior to or posterior to the new subframe groups.

20. The method according to claim 18, wherein the blank subframes of the predetermined groups are inserted prior to or posterior to the new subframe groups.
